(19) United States
(12) Patent Application Publication
(10) Pub. No.: US 2023/0015049 A1
(43) Pub. Date: Jan. 19, 2023

(54) SYSTEM AND METHOD FOR DETERMINING AUTHENTICITY OF A MOBILE DEVICE

(71) Applicant: SERVICE LEE TECHNOLOGIES PVT. LTD., Mumbai (IN)

(72) Inventor: Satish S. SUGGALA, Mumbai (IN)

(73) Assignee: SERVICE LEE TECHNOLOGIES PVT. LTD., Mumbai (IN)

(21) Appl. No.: 17/758,258

(22) PCT Filed: Feb. 12, 2020
(86) PCT No.: PCT/IN2020/050139

§ 371 Date: Jun. 30, 2022

(30) Foreign Application Priority Data
Dec. 31, 2019 (IN) 201921054655

(51) Int. Cl. H04W 12/06; H04W 12/71; H04W 12/63

(52) U.S. Cl. CPC H04W 12/06; H04W 12/71; H04W 12/63

(57) ABSTRACT

The present invention provides a system and process for determining the authenticity of a mobile device [101]. Upon a request initiated on an application of a mobile device [101], a first set of information is retrieved relating to at least one hardware component [203], which is transmitted to a remote server [104]. The remote server [104] then retrieves a second set of information based on first set of information from a data store [105]. The first, and second set of information are analyzed to determine a binary value for at least one hardware component [203]. Thereafter, a first value is obtained based on said binary value and at least one pre-assigned weighed value assigned to at least one hardware component. An authentication value is obtained by comparing the first value with a mobile phone specific threshold value. The authentication value is then transmitted to the mobile device [101].

### FIELD OF INVENTION

The present invention relates to determination of authenticity of an electronic device, more particularly, the invention relates to a system and method for fake mobile device detection.

### BACKGROUND OF THE INVENTION

The following description of related art is intended to provide background information pertaining to the field of the disclosure. This section may include certain aspects of the art that may be related to various features of the present disclosure. However, it should be appreciated that this section be used only to enhance the understanding of the reader with respect to the overall field of the invention, and not as admissions of prior art.

It is a well-known fact that the prevalence and ease of availability of counterfeit products has given helped the industry making counterfeit products earn huge profits. The industry is driven by the principle that a product, is worth disproportionately more than the cost of its manufacture, such as electronic devices, may be counterfeited at a profit. In fact, manufacturers of proprietary products lose billions of dollars each year because of ease of availability of counterfeits. Further, with the advertent of technology, the counterfeit goods may be produced of similar or identical quality to the original. Hence, a manufacturer suffers from a continuous loss of sales as counterfeiting continues unchecked, because detection is difficult or impossible.

Further, in case of counterfeit products which are components of a device, it is often required to dismantle the entire device to analyze the interior counterfeit components. Additionally, when analyzing the originality of the interior goods, which may be produced of similar or identical quality to the original, it may be difficult to ascertain if the interior goods are original or counterfeits.

There is a need in the art to introduce easy to use, quantitative, accurate, reproduceable and logic-based system and methods to evaluate the authenticity of the mobile device. Particularly, there is also an imperative need for a system and method for determining if the components of an electronic device are original, without having to dismantle the electronic device so as to maximize value, enhance efficiency and also achieving a high degree of accuracy.

### SUMMARY OF THE INVENTION

This section is provided to introduce certain objects and aspects of the present invention in a simplified form that are further described below in the detailed description. This summary is not intended to identify the key features or the scope of the claimed subject matter. In order to overcome at least a few problems associated with the known solutions as provided in the previous section, an object of the present invention is to provide for a system and method to determine if the mobile device is authentic.

An object of the present invention is to provide a system and method to determine the authenticity or originality of one or more component(s) of a mobile device without dismantling the mobile device.

Another object of the present invention is to provide a system and method to determine a residual value of a mobile device based on the authenticity or originality of one or more component(s) of the mobile device without dismantling the mobile device.

In view of the aforesaid objects of the present invention, a first aspect of the present invention relates to a method for determining the authenticity of a mobile device, wherein the method comprises initiating a request on at least one application configured to interact with at least one mobile device. A first set of information is retrieved relating to at least one hardware component of the mobile device. The first information may be region specific. The first set of information is then transmitted to a remote server. A second set of information is retrieved from a data store by the remote server. The second set of information is based on first set of information and is related to at least one OEM hardware component of the mobile device. The second information may be region specific. The first set of information and the second set of information are then analyzed to generate an authentication value. The analysis of the first and second set of information comprises comparing the first set of information and the second set of information.

A binary value is then determined for at least one hardware component of the mobile device based on the comparison. Thereafter, a first value for at least one hardware component is obtained by carrying out at least one calculation based on said binary value assigned to at least one hardware component of the mobile device and at least one pre-assigned weighed value assigned to at least one OEM hardware component of the mobile device. A residual value for the mobile device is then calculated based on the first value obtained for at least one hardware component of the mobile device. Finally, an authentication value is obtained by comparing the residual value with a mobile phone specific threshold value. The authentication value is then transmitted to the mobile device.

Another aspect of the invention relates to a system for determining the authenticity of a mobile device. The system comprises initiating a request on at least one application configured to interact with at least one mobile device. A first set of information is retrieved by the process of the mobile device relating to at least one hardware component of the mobile device. The first set of information is then transmitted to a remote server by the mobile device. The remote server is configured to retrieve a second set of information from a data store. The second set of information is based on first set of information and is related to at least one OEM hardware component of the mobile device. The remote server is further configured to analyze the first set of information and the second set of information to determine an authentication value. The analysis of the first and second set of information comprises comparing the first set of information and the second set of information. A binary value is then determined for at least one hardware component of the mobile device based on the comparison. Thereafter, the remote server is also configured to obtain a first value for at least one hardware component by carrying out at least one calculation based on said binary value assigned to at least one hardware component of the mobile device and at least one pre-assigned weighed value assigned to at least one OEM hardware component of the mobile device. The remote server is also configured to obtain a residual value for the mobile device based on the first value obtained for at least one hardware component of the mobile device. Finally, the remote server is also configured to determine an authentication value by comparing the residual value with a mobile phone specific threshold value. The authentication value is then transmitted to the mobile device by the remote server.

### BRIEF DESCRIPTION OF THE ACCOMPANYING DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon dearly illustrating the principles of the present disclosure. Some drawings may indicate the components using block diagrams and may not represent the internal circuitry of each component. It will be appreciated by those skilled in the art that disclosure of such drawings includes disclosure of electrical components or circuitry commonly used to implement such components.

Although exemplary connections between sub-components have been shown in the accompanying drawings, it will be appreciated by those skilled in the art, that other connections may also be possible, without departing from the scope of the invention. All sub components within a component may be connected to each other, unless otherwise indicated.

FIG. 1 illustrates an overview of an exemplary architecture of a system for determining the authenticity of a mobile device, in accordance with exemplary embodiments of the present invention.

FIG. 2 illustrates an exemplary architecture of a mobile device configured to determine the authenticity of a mobile device, in accordance with exemplary embodiments of the present invention.

FIG. 3 illustrates an exemplary flow chart representing the method for determining the authenticity of a mobile device, in accordance with exemplary embodiments of the present invention.

### DETAILED DESCRIPTION OF THE INVENTION

In the following description, for the purposes of explanation, various specific details are set forth in order to provide a thorough understanding of the embodiments of the present invention. It will be apparent, however, that embodiments of the present invention may be practiced without these specific details. Several features described hereafter can each be used independently of one another or with any combination of other features. An individual feature may not address any of the problems discussed above or might address only some of the problems discussed above. Some of the problems discussed above might not be fully addressed by any of the features described herein. Example embodiments of the present invention are described below, as illustrated in various drawings.

Those skilled in the art will be aware that the invention described herein is subject to variations and modifications other than those specifically described herein. It is to be understood that the invention described herein includes all such variations and modifications. The invention also includes all such steps, features, systems and methods referred to or indicated in this specification, individually or collectively, and any and all combinations of any two or more of said steps or features.

The present invention provides a system and method for determining the authenticity of a mobile device. The invention commences when a request is initiated by the user on at least one application configured to interact with at least one mobile device. A first set of information is retrieved relating to at least one hardware component of the mobile device.

The first information may be region specific. The first set of information is then transmitted to a remote server. The remote server retrieves a second set of information from a data store. The second set of information is based on first set of information and is related to at least one OEM hardware component of the mobile device. The second information may be region specific. The first set of information and the second set of information are the analyzed. The analysis of the first and second set of information comprises comparing the first information and the second information. A binary value is then determined for at least one hardware component of the mobile device based on the comparison. Thereafter, a first value for at least one component is obtained by carrying out at least one calculation based on said binary value assigned to at least one hardware component of the mobile device and at least one pre-assigned weighed value assigned to at least one OEM hardware component of the mobile device. A residual value for the mobile device is then calculated based on the first value obtained for at least one hardware component of the mobile device. Finally, an authentication value is obtained by comparing the residual value with a mobile phone specific threshold value. The authentication value is then transmitted to the mobile device.

As used herein, “connect”, “configure”, “couple” and its cognate terms, such as “connects”, “connected”, “configured”, “linked” and “coupled” may include a physical connection (such as a wired/wireless connection), a logical connection (such as through logical gates of semiconducting device), other suitable connections, or a combination of such connections, as may be obvious to a skilled person.

As used herein, “send”, “transfer”, “transmit”, and their cognate terms like “sending”, “sent”, “transferring”, “transmitting”, “transferred”, “transmitted”, “communicating”, “communicated” etc. include sending or transporting data or information from one unit or component to another unit or component, wherein the data or information may or may not be modified before or after sending, transferring, transmitting.

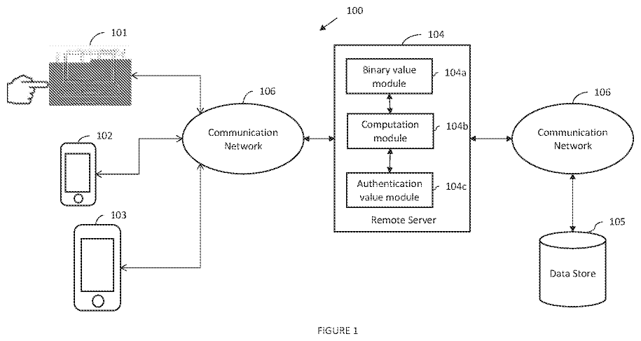

FIG. 1 illustrates an overview of an exemplary architecture of a system determining the authenticity of a mobile device in accordance with exemplary embodiments of the present invention. The system [100] comprises of at least one mobile device [101, 102, 103], a remote server [104] and a data store [105] As shown in the figure, the mobile device [101, 102, 103] may be connected to the remote server [104] and a data store [105] via a communication system [106]

As used herein, the mobile device [101], [102] and [103] may be separately referred to as mobile device [101], mobile device [102], mobile device [103] and so on and collectively as mobile device [101]. The mobile device [101] refers to any electrical, electronic, electromechanical and computing device. The mobile device [101] may include, but not limited to, a mobile phone, a tablet, a smartphone, a laptop, a wearable device, a personal digital assistant and any such device obvious to a person skilled in the art. Although only a limited number of mobile devices [101] are shown with reference to FIG. 1, however, it will be understood by those of ordinary skill in the art that the structure shown is merely illustrative and does not limit the number of the mobile devices [101] in the system [100] Similarly, although only one remote server [104] has been shown in Fig. 1, multiple remote server components and multiple remote servers are encompassed by the present disclosure.

The mobile device [101] is configured to initiate a request on an application configured to interact with the mobile device [101]. The invention encompasses that the mobile device [101] is configured to interact with an application. As used herein, an “application” refers to an application program designed to perform a group of coordinated functions, tasks, or activities for the benefit of the user of the application installed on the mobile device [101], including any application that uses at least one of the IP communication protocol and the non-IP communication protocol for transmission. In a preferred embodiment of the invention, the application is an application that can generate a request on the mobile device [101] to determine the authenticity of the mobile device [101]. In an embodiment, the application on the mobile device [101] may communicate with a remote server [104] to transmit the request to determine the authenticity of the mobile device [101]. The request may be transmitted using the communication system [106] In an embodiment, the application configured to interact with the mobile device [101] is located in said mobile device [101]. In another embodiment, the application configured to interact with the mobile device [101] is located at a remote location.

The mobile device [101] is also configured to determine a first set of information related to at least one hardware component of the mobile device [101]. As used herein, the first set of information may be the serial number of the at least one hardware component or any unique identification number associated with the at least one hardware component. For example, the first set of information may comprise of the unique manufacturing serial number of a camera in the mobile device [101]. In another example, the first set of information may comprise of the unique manufacturing serial number of a memory disk and the manufacturing serial number of the screen of the mobile device [101]. In an embodiment, the first information may be region specific. For example, the unique manufacturing serial number of a camera in the mobile device [101] may be peculiar for India. The mobile device [101] is also configured to transmit the first set of information to the remote server [104] The first set of information is transmitted using the communication system [106]

The mobile device [101] is further configured to receive an authentication value from the remote server [104] As used herein, the authentication value refers to a computed numeric, alphanumeric, symbol, color, graphic, percentage value for the mobile device [101] representing or depicting the authenticity of the mobile device [101].

The remote server [104] is configured to receive at least one first set of information related to at least one hardware component of the mobile device from the mobile device [101]. The remote server [104] is also configured to analyze the at least one first set of information related to at least one hardware component of the mobile device [101]. The remote server [104] is further configured to receive at least one second set of information related to at least one hardware component of the mobile device [101] from the data store [105] As used herein, the second set of information is based on first set of information and is related to at least one OEM hardware component of the mobile device [101]. In an embodiment, the second information may be region specific. As used herein, the second set of information may be the serial number of the at least one hardware component or any unique identification number associated with the at least one hardware component of the mobile device [101] assigned by an OEM of that at least one hardware component or the manufacturer of the mobile device [101]. The remote server [104] is also configured to analyze the first set of information and the second set of information. The invention encompasses that the remote server [104] may be a centralized server or a decentralized server.

As shown in the figure, the remote server [104] comprises of a binary module [104a], a computation module [104b] and an authentication value module [104c] Although only a limited number of modules are shown with reference to FIG. 1, however, it will be understood by those of ordinary skill in the art that the structure of the remote server [104] shown is merely illustrative and does not limit the number of the modules in the remote server [104] The invention further encompasses that one or more modules may be in one remote server [104] and one or more other modules may be in another remote server [104]

The invention encompasses that the binary module [104a] is configured to analyze the first set of information and second set of information by comparing the first set of information and the second set of information. The binary module [104a] is further configured to determine a binary value for at least one hardware component of the mobile device [101] based on the analysis. In an embodiment, the binary value may be a positive value if the comparison results in a match of the values. In another embodiment, the binary value may be a negative or null value if the comparison doesn't result in a match of the values. For example, if the first set of information comprising of the unique manufacturing serial number associated with the battery of the mobile device [101] matches the second set of information comprising the unique manufacturing serial number assigned by an OEM of the battery, then the binary value may be a positive value. If the values don't match, then the binary value may be a zero or a negative value. In another example, if the first set of information comprising of the unique ID associated with the camera of the mobile device [101] matches the second set of information comprising the unique ID assigned by an OEM of the camera, then the binary value may be 1. If the values don't match, then the binary value may be a zero.

The computation module [104b] of the remote server [104b] is configured to determine a first value for at least one hardware component by carrying out at least one calculation based on said binary value assigned to at least one hardware component of the mobile device [101] and at least one pre-determined weight value assigned to at least one OEM hardware component of the mobile device [101]. As used herein, the first value is the computed value indicating the authentication of at least one hardware component of the mobile device [101]. As used herein, the at least one pre-determined weight value assigned to at least one OEM hardware component of the mobile device [101] is a value representing the weight of the hardware component in determining the authenticity of the at least one OEM hardware component of the mobile device [101].

The computation module [104b] is further configured to determine a residual value for the mobile device [101] by carrying out at least one calculation based on said first value computed for at least one hardware component of the mobile device [101]. As used herein, the residual value is the computed value indicating the authentication of the mobile device [101] as a summation of the originality of the at least one hardware component of the mobile device [101]. The invention encompasses that the residual value is computed based on sum of at least one hardware component of the mobile device [101].

The authentication value module [104c] of the remote server [104b] is configured to determine an authentication value by comparing the determined residual value with a mobile phone specific threshold value. As used herein, the mobile phone specific threshold value may be a predetermined value representing a limit above which a mobile device [101] be will determined to be authentic in accordance with the embodiments of the present invention.

As used herein, a “remote server” or “server” includes one or more processors, wherein processor refers to any logic circuitry for processing instructions. A server may include a general purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The remote server [104] may perform signal coding data processing, input/output processing, and/or any other functionality that enables the working of the system according to the present disclosure.

The data store [105] is configured to store the second set of information. The data store [105] may include, but is not limited to, a volatile memory, non-volatile memory, a remote storage, a cloud storage, high-speed random-access memory and/or non-volatile memory, such as one or more magnetic disk storage devices, one or more optical storage devices, and/or flash memory (e.g., NAND, NOR) or a combination thereof. In some embodiments, data store [105] may further include memory remotely configured relative to the remote server [104] which may be connected to the mobile device [101] via a network. Embodiments of such networks include, but are not limited to, the Internet, intranets, local area networks, mobile communication networks, and combinations thereof.

The communication system [106] may be any wired or wireless communication network capable to transfer data packets between entities of that network such as such as a carrier network including circuit switched network, a public switched network, a CDN network, a LTE network, GSM network and UMTS network. In an embodiment, the communication network [106] may comprise of a network controller and a base station.

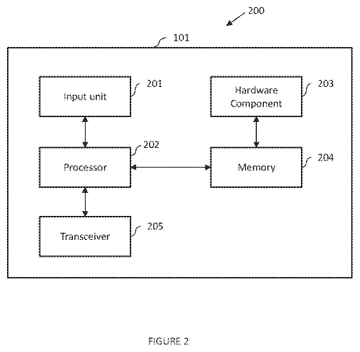

Referring to FIG. 2, an exemplary architecture [200] of a mobile device [101] configured to determine the authenticity of the mobile device [101] is depicted. According to the figure, the mobile device [101] comprises an input unit [201], a processor [202], at least one hardware component [203], a memory [204] and a transceiver [205] The mobile device [101] may also include more or less components than those illustrated in FIG. 2 or have a different configuration than that illustrated in this FIG. 2.

The input unit [201], connected to the transceiver [205] and the processor [202], is configured to receive an input from a user. It will be understood by those of ordinary skill in the art that the input unit [201], the processor [202], the at least one hardware component [203], the memory [204] and the transceiver [205], may be connected to each other using universal asynchronous receiver/transmitter (UART), general purpose input output (GPIO), serial peripheral interface (SPI), inter-integrated Circuit (I2C), but not limited to the above standards. In some examples, the connection may only include a bus, and in other examples, the connection may also include other components, such as one or more controllers.

The input unit [201] is configured to receive an input from the user to start the application. In an embodiment, input received from the user to start an application to determine the authenticity of the mobile device [101]. In an embodiment, the input received from the user may be to start an application of a first mobile device [101] to determine the authenticity of a second mobile device [102]

The invention encompasses that the input unit [201] may comprise a touch panel, a soft keypad, a hard keypad (including buttons) and the like. For example, the user may click a soft button on a touch panel of the input unit [201] to start the application. In another example, the user may touch an icon on the touch panel to start an application on a launcher of the mobile device [101].

In a preferred embodiment, the input unit [201] may be configured to receive an input from the user via a graphical user interface on a touch panel. As used herein, a “graphical user interface” may be a user interface that allows a user of the mobile device [101] to interact with the mobile device [101] through graphical icons and visual indicators, such as secondary notation, and any combination thereof. For example, the input unit [201] may include a touch panel configured to collect the user's input via touch operation, thereon or near the surface of the touch panel, and using a finger or a stylus. The invention encompasses that the detection of the touch on a graphical user interface of the input unit [201] can be realized by various types such as resistive, capacitive, infrared, and surface acoustic waves.

The input unit [201] is further configured to transmit the input received from the user to the processor [202] In an embodiment, the input unit [201] is configured to transmit the input received to the transceiver [205]

The processor [202] is configured to start the application of the mobile device [101] after the user input. The processor [202] is also configured to transmit the request to the remote server [104] via the transceiver [205] The processor [202] is further configured to retrieve the first set of information from the memory [204] In another embodiment, the processor [202] is configured to communicate with a data store [105] to retrieve the first set of information of the mobile device [101]. The processor [202] is configured transmit the first set of information to the remote server [104] via the transceiver [205]

The processor [204] is further configured to receive the authentication value from the remote server [104] and display it on the mobile device [101].

As used herein, a “processor” or “processing unit” includes one or more processors, wherein processor refers to any logic circuitry for processing instructions. A processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor [202] may perform signal coding data processing, input/output processing, and/or any other functionality that enables the working of the system according to the present disclosure. More specifically, the processor [202] or processing unit is a hardware processor.

The at least one hardware component [203] may be any hardware component or part of the mobile device [101] which is necessary for the effective functioning of the mobile device [101]. For example, a hardware component [203] may be any one or more of, but is not limited to the, display, processor(s), memory unit(s) such as GPU, CPU, camera(s), battery, sensor(s) such as light sensor, proximity sensor, accelerometer, barometer, compass, gyroscope, speaker(s), GPS, NFC, and Wi-Fi chip(s), antennas, mother board or any other such hardware component of the mobile device [203] which is necessary for the effective functioning of the mobile device [101]. The memory [204] is configured to store software programs and modules. The memory [204] is further configured to store the first set of information of the mobile device [101]. The memory [204] is further configured to allow the processor [202] to execute various functional disclosures and data processing by running software programs and modules stored in the memory [204] The memory [204] may include, but is not limited to, a volatile memory, non volatile memory, a remote storage, a cloud storage, high-speed random-access memory and/or non-volatile memory, such as one or more magnetic disk storage devices, one or more optical storage devices, and/or flash memory (e.g., NAND, NOR) or a combination thereof. In some embodiments, memory [204] may further include memory [204] remotely configured relative to processor [202] which may be connected to a first mobile device [101] and/or a second mobile device [102] and the processor [202] via a network. Embodiments of such networks include, but are not limited to, the Internet, intranets, local area networks, mobile communication networks, and combinations thereof.

The transceiver [205] is configured to transmit data from the mobile device [101] to the remote server [104] In an embodiment, the transceiver [205] is configured to receive a request from the input unit [201] to start an application. In another embodiment, the transceiver [205] in response to the request received from the input unit [201] sends the request to the remote server [104] The transceiver [205] is also configured to receive the first set of information from the processor [202] The transceiver [205] is further configured to transmit the first set of information to the remote server [104] For example, the transceiver [205] may receive the manufacturing serial number of the camera and the battery as the first set of information and transmit it to the remote server [104]

The transceiver [208a] is also configured to receive the authentication value from the remote server [104] For example, the authentication value of 85% of the mobile device [101] may be received from the remote server [104]

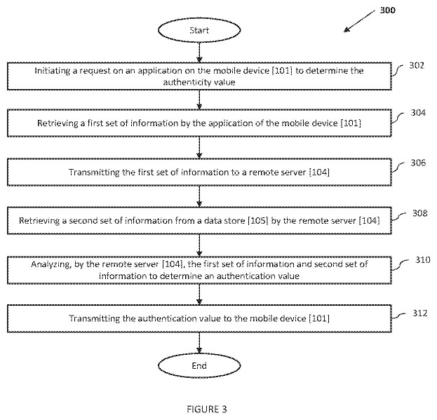

Referring to FIG. 3, an exemplary method for determining the authenticity of a mobile device in accordance with exemplary embodiments of the present invention. At step 302, the method commences by initiating a request on an application on the mobile device [101]. In an embodiment, the invention encompasses that the request is initiated on a second mobile device [102] to determine the authenticity of a first mobile device [101], wherein the second mobile device [102] is linked or coupled to the first mobile device [102] The invention encompasses that the request is initiated on the application by the processor [202] of the mobile device [102] In an embodiment, the request is initiated on the application by the processor [202] of the second mobile device [102] The request is initiated on an application stored on or interacting with the mobile device [101].

The invention encompasses that the request is received from the user by the input unit [201] For example, the user may click a soft button on a touch panel of the input unit [201] to open the application on the mobile device [101]. In another example, the user may touch an icon on the touch panel to start the application on a launcher of the mobile device [101].

At step 304, a first set of information is retrieved by the application, via the processor [202], of the mobile device [101]. The invention encompasses that the first set of information is related to at least one hardware component [203] of the mobile device [101]. The first information may be region specific. In an embodiment, the first set of information related to at least one hardware component [203] of the mobile device [101] is retrieved by an application of the second mobile device [102] For example, the application may retrieve the unique manufacturing serial number of a camera in the mobile device [101] as the first set of information. In another example, the application may retrieve the unique manufacturing serial number of a memory disk and the manufacturing serial number of the screen of the mobile device [101] as the first set of information.

At step 306, the first set of information is transmitted to the remote server [104] The first set of information is transmitted using the communication system [106]

At step 308, the remote server [104] retrieves a second set of information from the data store [105] The invention encompasses that the second set of information is based on first set of information. The second set of information is related to at least one OEM hardware component of the mobile device [101]. In an embodiment, the second information may be region specific. The second set of information may be the serial number of the at least one hardware component [203] or any unique identification number associated with the at least one hardware component assigned by an OEM of that at least one hardware component [203] or the manufacturer of the mobile device [101]. For example, the remote server [104] may retrieve the unique manufacturing serial assigned by an OEM of a camera in the mobile device [101] as the second set of information from the data store [105] In another example, the remote server [104] may retrieve the unique manufacturing serial of a memory disk and the manufacturing serial number of the screen of the mobile device [101] assigned by an OEM as the second set of information from the data store [105]

At step 310, the first set of information and second set of information are analyzed to determine an authentication value. The invention encompasses that determining the authenticity of the mobile device [101] based on the authenticity of the at least one hardware component [203] For example, the first set of information comprising of the unique manufacturing serial number associated with a camera of the mobile device [101] and the second set of information comprising the unique manufacturing serial number assigned by an OEM of the camera of the mobile device [101] are analyzed to determine an authentication value.

The invention encompasses determining the authentication value by comparing the first set of information and the second set of information to determine a binary value for at least one hardware component of the mobile device [101] by the binary module [104a] of the remote server [104] In an embodiment, the binary value may be a positive value if the comparison results in a match of the values. In another embodiment, the binary value may be a negative or null value if the comparison doesn't result in a match of the values. For example, if the first set of information comprising of the unique manufacturing serial number associated with the battery of the mobile device [101] matches the second set of information comprising the unique manufacturing serial number assigned by an OEM of the battery, then the binary value may be a positive value. If the values don't match, then the binary value may be a zero or a negative value. In another example, if the first set of information comprising of the unique ID number associated with the camera of the mobile device [101] matches the second set of information comprising the unique ID number assigned by an OEM of the camera, then the binary value may be 1. If the values don't match, then the binary value may be a zero.

The invention further encompasses determining a first value for at least one hardware component [203] of the mobile device [101] by the computation module [104b] of the remote server [104] The first value for at least one hardware component [203] is determined by at least one calculation based on said binary value assigned to at least one hardware component [203] of the mobile device [101] and at least one pre-determined weight value assigned to at least one OEM hardware component [203] of the mobile device [101]. In an embodiment, the first value may be product of the binary value and the pre-determined weight value for a hardware component [203] of the mobile device. For example, the first value may be a product of the binary value of the camera and the pre-determined weight value of camera.

The invention further encompasses determining a residual value for the mobile device [101] by the computation module [104b] of the remote server [104] The residual value is calculated based on the first value obtained for at least one hardware component [203] of the mobile device [101]. The residual value is a sum of the first values of at least two hardware components [203] of the mobile device [101]. In an embodiment, when there is only one hardware component [203], then the residual value is equal to the first value of that hardware component [203] of the mobile device [101]. For example, the residual value of the mobile phone [101] may be a sum of the first value of the camera and the first value of the display screen of the mobile device.

The invention further encompasses determining an authentication value by comparing the determined residual value with a mobile phone specific threshold value by the authentication value module [104c] of the remote server [104]

At step 312, the authentication value of the mobile device [101] is transmitted to the mobile device [101]. In an embodiment, the authentication value of a first mobile device [101] is transmitted to a second mobile device [102] The authentication value is transmitted using the communication system [106]

In an exemplary embodiment, a request may be initiated to start an application on the mobile device [101] to determine the authenticity of the mobile device [101]. The request is initiated on the application by the processor [202] of the mobile device [101]. The request is received from the user by clicking a soft button on a touch panel of the input unit [201] to open the application on the mobile device [101]. Upon receipt of the request, a first set of information is retrieved by the application of the mobile device [101] comprising of the information related to at least one hardware component [203] of the mobile device [101]. For example, the first set of information may be the unique manufacturing serial numbers of the camera and the battery in the mobile device [101]. The request and the first set of information is then transmitted to a remote server [104] using the communication system [106]

Upon receipt of the request and the first set of information, the remote server [104] retrieves a second set of information from a data store [105] comprising of the unique manufacturing serial assigned by an OEM of a camera and the battery in the mobile device [101].

The remote server [104] then analyses the first set of information and second set of information to determine an authentication value for the mobile device [101]. The remote server [104] compares the first set of information and the second set of information to determine a binary value for camera and the battery in the mobile device [101]. If the first set of information comprising of the unique manufacturing serial number associated with the camera and battery of the mobile device [101] matches the second set of information comprising the unique manufacturing serial number assigned by an OEM of the camera and battery, then the binary value may be a positive value, such as 1. If the values don't match, then the binary value may be a 0. The remote server [104] then determines a first value for at least one hardware component [203] of the mobile device [101]. The first value of at least one hardware component [203], such as the camera, is calculated by computing the result of the binary value of the camera times the pre-determined weight value assigned to the camera. Similarly, the first value for the battery is calculated by computing the result of the binary value of the battery times the pre-determined weight value assigned to the battery. Thereafter, a residual value for the mobile phone [101] is calculated based on said first values of the camera and battery of the mobile device [101]. The residual value is a sum of all the first values for the camera and the battery of the mobile device [101].

The authentication value is then determined by comparing the determined residual value with a mobile phone specific threshold value. The authentication value of the mobile device [101] is then transmitted to the mobile device [101] using the communication system [106]

In another exemplary embodiment, a request may be initiated to start an application on a first mobile device [101] to determine the authenticity of a second mobile device [102] The request is initiated on the application by the processor [202] of the mobile device [101]. The request is received from the user by clicking a soft button on a touch panel of the input unit [201] to open the application on the mobile device [101]. Upon receipt of the request, a first set of information of the second mobile device [102] is retrieved by the application of the first mobile device [101] comprising of the information related to at least one hardware component [203] of the mobile device [102] For example, the first set of information may be the unique manufacturing serial number of a display screen of the second mobile device [102] The request and the first set of information is then transmitted to a remote server [104] using the communication system [106]

Upon receipt of the request and the first set of information, the remote server [104] retrieves a second set of information from a data store [105] comprising of the unique manufacturing serial assigned by an OEM of a display screen of the second mobile device [102]

The remote server [104] then analyses the first set of information and second set of information to determine an authentication value for the second mobile device [102] The remote server [104] compares the first set of information and the second set of information to determine a binary value for display screen in the second mobile device [102] If the first set of information comprising of the unique manufacturing serial number associated with the display screen of the second mobile device [102] matches the second set of information comprising the unique manufacturing serial number assigned by an OEM of the display screen, then the binary value may be a positive value, such as 1. If the values don't match, then the binary value may be a 0. The remote server [104] then determines a first value for at least one hardware component [203] of the second mobile device [102] The first value of at least one hardware component [203], such as the display screen, is calculated by computing the result of the binary value (1,0) of the display screen times the pre-determined weight value assigned to the display screen. Thereafter, a residual value for the mobile phone [101] is calculated based on said first value of the display screen of the mobile device [101]. The residual value is the first value computed for the display screen of the mobile device [101].

The authentication value is then determined by comparing the determined residual value with a mobile phone specific threshold value for the second mobile device [102] The authentication value of the mobile device [102] is then transmitted to the first mobile device [101] using the communication system [106]

In yet another exemplary embodiment, a request may be initiated to start an application on the mobile device [101] to determine the authenticity of the mobile device [101]. The request is initiated on the application by the processor [202] of the mobile device [101]. The request may be received from the user by clicking a soft button on a touch panel of the input unit [201] to open the application on the mobile device [101]. Upon receipt of the request, a first set of information is retrieved by the application of the mobile device [101] comprising of the information related to at least one hardware component [203] of the mobile device [101]. For example, the first set of information may be the unique manufacturing serial numbers of the display, processor, memory, camera and the battery in the mobile device [101]. The request and the first set of information is then transmitted to a remote server [104] using the communication system [106]

Upon receipt of the request and the first set of information, the remote server [104] retrieves a second set of information from a data store [105] comprising of the unique manufacturing serial assigned by an OEM of the display, processor, memory, camera and the battery in the mobile device [101].

The remote server [104] then analyses the first set of information and second set of information to determine an authentication value for the mobile device [101]. The remote server [104] compares the first set of information and the second set of information to determine a binary value for the display, processor, memory, camera and the battery in the mobile device [101]. If the first set of information comprising of the unique manufacturing serial number associated with the display, processor, memory, camera and the battery in the mobile device [101] matches the second set of information comprising the unique manufacturing serial number assigned by an OEM of the display, processor, memory, camera and the battery, then the binary value may be 1, for each of the components individually. If the values don't match, then the binary value may be a 0, for each of the components individually. The remote server [104] then determines a first value for each of the hardware components [203] of the mobile device [101]. The first value of at least one hardware component [203], such as the display, is calculated by computing the result of the binary value of the display times the pre-determined weight value assigned to the display. Similarly, the first value for each of the components of processor, memory, camera and the battery may be computed. The first value for the display may be (30*1) when the binary value is computed to be 1 in case of a match and the pre-determined weight value assigned to the display is 30. Similarly, the first value for the processor may be (25*1) when the binary value is computed to be 1 in case of a match and the pre-determined weight value assigned to the processor is 25. Again, the first value for the memory may be (20*1) when the binary value is computed to be 1 in case of a match and the pre-determined weight value assigned to the memory is 20. The first value for the camera may be (15*1) when the binary value is computed to be 1 in case of a match and the pre-determined weight value assigned to the camera is 15. The first value for the battery may be (10*1) when the binary value is computed to be 1 in case of a match and the pre determined weight value assigned to the camera is 10.

Thereafter, a residual value for the mobile phone [101] is calculated based on said first values of the display, processor, memory, camera and the battery of the mobile device [101]. The residual value is a sum of all the first values for the display, processor, memory, camera and the battery of the mobile device [101]. That is, the residual value will be (30*1)+(25*1)+(20*1)+(15*1)+(10*1), that is, 100.

The authentication value is then determined by comparing the determined residual value with a mobile phone specific threshold value. For example, the residual value of 100 may be compared of a mobile phone specific threshold value of 85 to determine if the mobile [101] is authentic. The authentication value of the mobile device [101], such as PASS, is then transmitted to the mobile device [101] using the communication system [106]

In another scenario, the first value for the display may be (30*1) when the binary value is computed to be 0 in case of a mismatch and the pre-determined weight value assigned to the display is 30. Similarly, the first value for the processor may be (25*0) when the binary value is computed to be 0 in case of a mismatch and the pre-determined weight value assigned to the processor is 25 and the first value for the memory, camera and battery may be (20*1), (15*1) and (10*1) respectively.

Thereafter, a residual value for the mobile phone [101] may be calculated based on said first values of the display, processor, memory, camera and the battery of the mobile device [101]. The residual value is a sum of all the first values for the display, processor, memory, camera and the battery of the mobile device [101]. That is, the residual value will be (30*0)+(25*0)+(20*1)+(15*1)+(10*1), that is, 55.

The authentication value may be then determined by comparing the determined residual value with a mobile phone specific threshold value. For example, the residual value of 55 may be compared of a mobile phone specific threshold value of 85 to determine if the mobile [101] is authentic. The authentication value of the mobile device [101], such as FAKE, is then transmitted to the mobile device [101] using the communication system [106]

The units, interfaces, modules, and/or components depicted in the figures and described herein may be present in the form of a hardware, a software and a combination thereof. Connection/s shown between these units/components/modules/interfaces in the exemplary system architecture may interact with each other through various wired links, links, logical links and/or physical links. Further, the units/components/modules/interfaces may be connected in other possible ways.

While considerable emphasis has been placed herein on the disclosed embodiments, it will be appreciated by those skilled in the art that many changes can be made to the embodiments disclosed herein without departing from the principles and scope of the present invention.

1. A system [100] for determining the authenticity of a mobile device [101], comprising:
a. at least one application configured to interact with at least one mobile device [101];
b. at least one remote server [104] configured to said at least one application;
c. at least one data store [105] configured to interact with said at least one remote server [104]; and
wherein the remote server [104] is configured to,
i. receive a first set of information from mobile device [101], wherein the first set of information is related to at least one hardware component of the mobile device [101]; and
ii. retrieve a second set of information from the data store [104], wherein the second set of information is based on first set of information; and iii. analyze the first set of information and the second set of information to determine an authentication value; and
iv. transmit the authentication value to mobile device [101].

2. The system [100] as claimed in claim 1, wherein said first set of information may include information related to at least one hardware component [203] of the mobile device [101], including a device identifier.

3. The system [100] as claimed in claim 2, wherein said first set of information may be region specific.

4. The system [100] as claimed in claim 1, wherein said second set of information comprises information related to at least one OEM hardware component of the mobile device [101], including device identifier.

5. The system [100] as claimed in claim 4, where said second set of information may be region specific.

6. The system [100] as claimed in claim 1, wherein analysis, by a binary module [104a], of the first set of information and the second set of information comprises comparing at least one of the first set of information and the second set of information of the mobile device [101] to determine at least one binary value for at least one hardware component [203] of the mobile device [101].

7. The system [100] as claimed in claim 6, further comprising obtaining, by a computation module [104b], a first value by carrying out at least one calculation based on said at least one binary value for at least one hardware component [203] of the mobile device [101] and at least one pre-assigned weighed value for the at least one OEM hardware component of the mobile device.

8. The system [100] as claimed in claim 7, further comprising obtaining, by the computation module [104b], a residual value for the mobile device [101] by carrying out at least one calculation based on said at least one first value for at least one hardware component [203] of the mobile device [101].

9. The system [100] as claim in claim 8, further comprising comparing, by an authentication module [104c], the residual value with a mobile phone specific threshold value to obtain the authentication value for the mobile device [101].

10. The system [100] as claimed in claim 1, wherein said at least one application configured to interact with at least one mobile device [101] is located in said at least one mobile device [101] or at a remote location.

11. The system [100] as claimed in claim 1, wherein said remote sever [104] is a distributed server.

12. The system [100] as claimed in claim 1, wherein said data store [104] is distributed data store.

13. (canceled)

14. A method [300] of determining the authenticity of a mobile device [101], the method [300] comprising:
a. initiating [302], by an input unit [201], a request on at least one application configured to interact with at least one mobile device [101];
b. retrieving [304], by the processor [203] a first set of information related to at least one hardware component [203] of the mobile device [101];
c. transmitting [306], by the transceiver [205], the first set of information to a remote server [104];
d. retrieving [308], by the remote server [104], a second set of information from a data store [105] based on first set of information;
e. analyzing [310], by the remote server [104], first set of information and second set of information to determine an authentication value; and
f. transmitting [312], by the remote server [104], the authentication value to the mobile device [101].

15. The method [300] as claimed in claim 14, wherein said first information may be region specific.

16. The method [300] as claimed in claim 14, wherein said second set of information comprises information related to at least one OEM hardware component of the mobile device [203], including device identifier.

17. The method [300] as claimed in claim 16, wherein said second information may be region specific.

18. The method [300] as claimed in claim 14, wherein analyzing, by a binary module [104a], of first set of information and second set of information comprises comparing at least one of the first set of information and the second set of information of the mobile device [101] to determine a binary value for at least one hardware component [203] of the mobile device [101].

19. The method [300] as claimed in claim 18, further comprising, by a computation module [104b], obtaining a first value by carrying out at least one calculation based on said at least binary value for at least one hardware component [203] of the mobile device [101] and at least one pre-assigned weighed value for the at least one OEM hardware component of the mobile device [101].

20. The method [300] as claimed in claim 19, further comprising obtaining, by the computation module [104b], a residual value for the mobile device [101] by carrying out at least one calculation based on said at least one first value for at least one hardware component [203] of the mobile device [101].

21. The method [300] as claimed in claim 20, further comprising, by an authentication value module [104c], comparing the residual value with a mobile phone specific threshold value to obtain the authentication value for the mobile device [101].
